(19) United States
(12) Patent Application Publication
(10) Pub. No.: US 2009/0064588 A1
(43) Pub. Date: Mar. 12, 2009

(54) Security Screen Assembly

(76) Inventor: Jim Reid, Hope Island (AU)

Correspondence Address: MEYERTONS, HOOD, KIVLIN, KOWERT & GOETZEL, P.C., P.O. BOX 398, AUSTIN, TX, 78767-0398, US

(21) Appl. No.: 11/667,904

(22) PCT Filed: Nov. 15, 2005
(86) PCT No.: PCT/AU05/01736

§ 371 Date: Jul. 24, 2008

(30) Foreign Application Priority Data
Nov. 15, 2004 (AU) 2004906510

(51) Int. Cl. E06B 9/01

(52) U.S. Cl. 49/50

(57) ABSTRACT

A frame assembly for a security screen comprising an outer frame, a screen, an attachment means, and an interconnecting means, wherein the attachment means attaches the screen to the interconnecting means and the interconnecting means interconnects the screen and the outer frame, and wherein the screen is electrically isolated from the outer frame.

### FIELD OF THE INVENTION

The present invention relates to domestic and commercial security.

### BACKGROUND OF THE INVENTION

Typical security screens are installed in windows, doors and other openings of buildings. Typically security screens are made from a wire mesh material which resists vandalism or attempted unauthorised entry to buildings. In addition the wire screen still allows acceptable vision to the exterior of the building.

Different types of security screen designs have been developed including a security screen which is fixed to an outer frame by fastening screws. A security screen of this type is disclosed in U.S. Pat. No. 4,932,457.

Electrolysis resulting in corrosion or rusting is a common problem for frame assemblies of the type disclosed in the above referenced US patent. The present invention in its preferred form is aimed at limiting such problems.

### SUMMARY OF THE INVENTION

According to one aspect of the present invention there is provided a frame assembly for a security screen comprising an outer frame, a screen, an attachment means, and an interconnecting means, wherein the attachment means attaches the screen to the interconnecting means and the interconnecting means interconnects the screen and the outer frame and wherein the screen is electrically isolated from the outer frame.

According to another aspect of the present invention there is provided a frame assembly for a security screen comprising an outer frame, a screen, an attachment means and an isolating means, wherein the attachment means attaches the screen to the outer frame and the isolating means electrically isolates the attachment means from the screen.

According to a further aspect of the present invention there is provided a frame assembly for a security screen comprising an outer frame, a screen, an attachment means and an interconnecting means wherein the attachment means attaches the screen to the interconnecting means and the interconnecting means connects the screen to the outer frame and wherein the screen attachment means, interconnecting means and outer frame each comprise the same conductive material.

According to one embodiment the interconnecting means comprises an intermediate coupling means for coupling with a frame coupling means of the outer frame.

Preferably the intermediate coupling means comprises at least one male or female portion which is configured to couple with a complimentary male or female portion of the frame coupling means.

Preferably the intermediate coupling means comprises a plurality of male or female, or male and female portions configured to couple with complimentary female or male or female and male portions of the frame coupling means.

The intermediate coupling means may comprise lateral coupling portions.

The lateral coupling portions preferably comprise peripheral grooves.

The lateral coupling portions may be arranged symmetrically on opposite sides of the interconnecting means.

The peripheral grooves may be arranged symmetrically on opposite sides of the interconnecting means.

The intermediate means preferably comprises a conductive means and/or a non-conductive means.

The conductive means preferably comprises a conductive part.

The non-conductive means preferably comprises a non-conductive part.

According to one embodiment the interconnecting means comprises both non-conductive and conductive parts.

The attachment means in use preferably attaches to the conductive part.

The conductive part may be coupled to the non-conductive part.

Preferably the conductive part and non-conductive parts each have coupling portions which are complimentary in configuration to allow the parts to be coupled together.

Preferably the non-conductive part is configured to be located between the outer frame and the conductive part.

Preferably the conductive part comprises an elongate member having lateral extending base portions.

The base portions may comprise substantially flat horizontal walls extending from vertical side walls of the conductive parts.

The conductive member may have a substantially flat top wall.

Preferably the flat top wall is substantially horizontal.

The non-conductive member or part may be configured to extend alongside/adjacent a portion of the outer frame.

Preferably the non-conductive member comprises a screen mesh shielding portion configured to extend between an inner edge of the screen mesh and adjacent side wall of the outer frame.

Preferably the screen is a wire screen mesh.

The non-conductive member may include the intermediate coupling means.

Preferably the lateral portions of the conductive part are configured to fit into complimentary shaped recesses/grooves of the non-conducting part.

The non-conducting part may have an outer end portion which separates an adjacent part of the screen mesh from part of the outer frame.

It is preferred that the attachment means comprises a clamping means for clamping the screen mesh to the intermediate means.

The attachment means may comprise a clamping means for clamping the screen mesh to the conductive part.

The clamping means may comprise a clamping member.

Preferably the clamping member is arranged to abut an inner portion of the screen mesh.

The clamping member may comprise a generally planar member.

Preferably the attachment means comprises a fastener such as a rivet or a screw.

The attachment means in use may extend through the clamping member, screen and intermediate means.

According to one embodiment the attachment means in use extends through the clamping member screen and conductive part.

The frame assembly may include a cover for covering the fastener.

The cover may include an attachment portion for attachment to the outer frame.

Alternatively the cover may be attached to the frame by an adhesive means such as a double-sided tape.

Preferably the non-conductive means/part comprises a plurality of separate parts.

The conductive part may have a substantially flat lower surface.

Preferably the conductive part comprises a tubular member.

The non-conductive part may extend around the side walls and base of the conductive part.

Preferably the conductive part is attached by adhesive to the non-conductive part.

The conductive part may comprise a metal insert.

The conductive part may comprise a conductive strip.

The non-conductive means may comprise a solid non-conductive member with the conductive part embedded therein.

The conductive part may be a planar member.

Preferably the intermediate coupling means comprises attachment members such as fasteners, like rivets or screws.

Preferably the outer frame includes a channel portion for receipt of the interconnecting means.

Preferably the channel portion is configured to receive the non-conductive member.

The non-conductive member may comprise an upper side wall portion configured to abut an inner side wall of the channel portion.

The intermediate coupling means preferably fastens the upper side wall portion to the one inner side wall of the outer frame.

Preferably the intermediate coupling means fastens a side portion of the non-conductive member to an outer side wall of the outer frame.

Preferably the non-conducting means comprises a solid member without an embedded conductive member.

The attachment means may attach the screen to the non-conductive means.

According to one embodiment there is no conductive means.

According to another embodiment the intermediate coupling means comprises an adhesive.

According to a further embodiment there is no non-conductive means.

The conductive means may comprise a conductive member with the intermediate coupling portions for coupling the conductive means to the outer frame.

The non-conductive means may comprise a generally rectangular block with an upstanding thin wall on one side.

Preferably the non-conductive means comprises a generally rectangular block with a lip or ridge on an opposite side.

Preferably the non-conductive means is received in a channel of the outer frame.

Preferably the upstanding thin wall is attached to the outer frame.

According to one embodiment the intermediate means is a conductor and the outer frame is a non-conductor.

According to a further embodiment the non-conductive member comprises a lateral wall portion extending from one side of the generally rectangular block.

The lateral wall may extend from an upright thin wall.

Preferably the lateral wall comprises a horizontal ledge.

The side wall and lateral wall preferably abut adjacent walls of the outer frame.

The lateral wall may be fixed to the top wall of the outer frame by a fastening means.

According to one embodiment the flat conductive member is located in the generally rectangular block.

The fastening means may comprise a fastening member which extends through the conductive member.

Preferably the non-conductive member comprises a generally rectangular channel with an upper opening.

The conductive member may fit into the channel through the opening.

Preferably the conductive member has a configuration similar to part of the internal profile of the non-conductive member.

The conductive member may comprise left and right side wall portions which abut corresponding portions of the non-conductive member.

The conductive member may have a flat top wall.

Preferably a fastener attaches to the flat top wall.

According to one embodiment of the present invention the isolating means comprises a sleeve member configured to fit through an opening in the screen.

Preferably the isolating means comprises a washer to prevent the sleeve from falling through a hole within the screen.

Preferably the attachment means comprises a fastener which in use fits through the sleeve member.

The isolating means may fit through the clamping member.

The clamping member may comprise a flat strip.

Preferably the frame assembly comprises at least one insulating strip located in use between the screen and a top wall portion of the outer frame.

The frame assembly may comprise at least one insulating strip between ends of the screen and side wall portion of the outer frame.

The sleeve member may be a tubular member with a top collar.

According to one embodiment the conductive member comprises a lateral wall in use adapted to extend over a top wall portion of the outer frame.

The conductive member may comprise a generally rectangular portion.

Preferably the conductive member comprises an upstanding wall portion extending from one side.

The side wall portion may have an opening for receipt of the isolating means.

The non-conductive means may comprise an insulation member extending along a portion of the outer frame to separate the conductive member from it.

The isolating means preferably extends through the insulator member.

It is preferred that the interconnecting means comprises at least one insulating member.

According to another embodiment of the present invention the interconnecting means comprises a plurality of insulating members.

Preferably the interconnecting means comprises a non-conductive clamping member having upper and lower clamping walls.

The non-conducting clamping member may be substantially C/U-shaped.

The non-conducting clamping member is preferably configured to sit on supporting walls of the outer frame.

The non-conductive member may comprise a lower foot portion extending from the lower clamping wall.

The interconnecting means may comprise a channel component which is non-conductive and is configured to be located within a recessed area of the outer frame.

The outer frame preferably includes an inner support portion comprising support walls forming a recess.

It is preferred that the interconnecting means includes a conductive member which is configured to be located below the non-conductive member.

Preferably the conductive member is housed within a non-conductive sheath member.

Preferably the non-conductive sheath member rests on supporting lugs in the recess.

Preferably the attachment means comprises a fastener which is configured to extend through the non-conductive members and the conductive member, but not through the outer frame.

It is preferred that in the embodiments and variations of the invention outlined above the clamping strip is conductive and therefore isolated from the outer frame when it is conductive. However an insulating clamping strip may be used. In such a situation the clamping strip may touch the outer frame and accordingly the embodiments described before and after may be altered so that the clamping strip may touch any other component in the frame assembly.

### BRIEF DESCRIPTION OF THE DRAWINGS

Preferred embodiments of the present invention will now be described by way of example only with reference to the accompanying drawings in which:

FIG. 1 shows a cross-sectional end view of a frame assembly according to a first embodiment;

FIG. 2 shows a cross-sectional end view of a frame assembly according to a second embodiment;

FIG. 3 shows a cross-sectional end view of a frame assembly according to a third embodiment;

FIG. 4 shows a cross-sectional end view of a frame assembly according to a fourth embodiment;

FIG. 5 shows a cross-sectional end view of a frame assembly according to a fifth embodiment;

FIG. 6 shows a cross-sectional end view of a frame assembly according to a sixth embodiment;

FIG. 7 shows a cross-sectional end view of a frame assembly according to a seventh embodiment;

FIG. 8 shows a cross-sectional end view of a frame assembly according to an eighth embodiment;

FIG. 9 shows a cross-sectional end view of a frame assembly according to a ninth embodiment;

FIG. 10 shows a cross-sectional end view of a frame assembly according to a tenth embodiment;

FIG. 11 shows a cross-sectional end view of a frame assembly according to an eleventh embodiment;

FIG. 12 shows a cross-sectional end view of a frame assembly according to a twelfth embodiment;

FIG. 13 shows a cross-sectional end view of a frame assembly according to a thirteenth embodiment;

FIG. 14 shows a cross-sectional end view of a frame assembly according to a fourteenth embodiment;

FIG. 15 shows a cross-sectional end view of a frame assembly according to a fifteenth embodiment;

FIG. 16 shows a cross-sectional end view of a frame assembly according to a sixteenth embodiment;

FIG. 17 shows a cross-sectional end view of a frame assembly according to a seventeenth embodiment of the present invention; and

FIG. 18 shows a cross-sectional end view of the frame assembly component according to an eighteenth embodiment of the present invention.

### DETAILED DESCRIPTION OF THE DRAWINGS

For convenience the Figures are described with the left side corresponding to the outside of the frame assembly and the right side corresponding to the inside of the frame assembly.

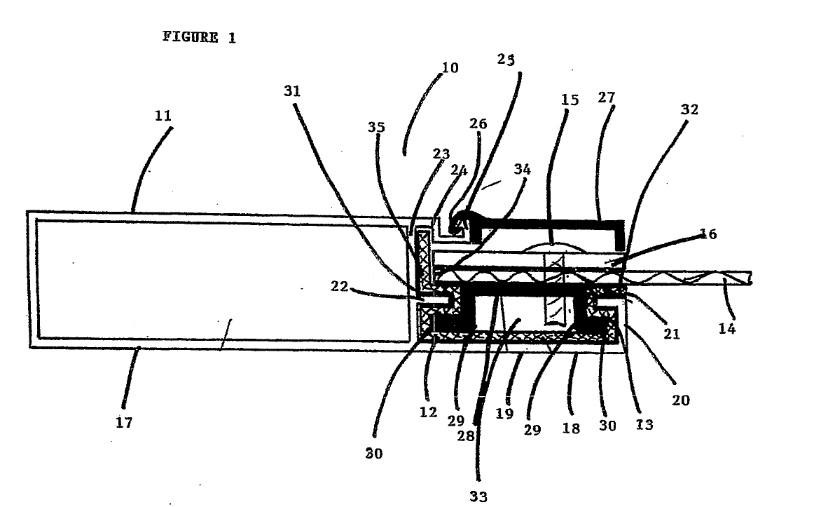

The frame assembly 10 shown in FIG. 1 consists of an outer frame 11, a non-conductive insert 12, a metal insert 13, a wire screen mesh 14 which is attached to the metal insert 13 through a fastening rivet or screw 14 and a conductive clamping strip 16.

The outer frame 11 consists of a large rectangular tubular outer section 17 with an inner (right side) channel 18 formed by a lateral base wall section 19 extending from the base wall of rectangular section 17. At its outer end the base wall section 19 extends vertically upwardly through vertical wall section 20 and inwardly (to the left) through horizontal ridge section 21.

Inner Side wall 23 of rectangular section 17 also has a small inwardly directed lateral horizontal wall 22 facing wall section 21, and together with section 21 wall 20 and base wall 19, form channel 18.

The non-conductive insert 12 abuts the top surface of wall section 21 and extends around the inner surface of the channel 18 along walls 20 and 19 and up and around wall section 22 and vertically upwardly alongside and in abutting relationship with the corresponding side wall 23 of rectangular section 17.

The top end of the non-conductive insert 12 terminates just below a top inwardly directed lateral wall extension 24 of side wall 23. Wall 24 initially extends laterally horizontally then vertically downwardly and laterally horizontally away from side wall 23 and then vertically upwardly to terminate in a catch 25 which is configured to engage with a matching catch 26 of a cover 27 which covers the fastener 15. The cover 27 extends upwardly from the outer edge of clamping strip 16 and then at right angles (outwardly of the left) to the opposite end where it terminates in catch 26.

Metal insert 13 fits into the channel 12 and has a horizontal top wall 28 with short vertical side walls 29 which each at their bottom ends extend horizontally laterally outwardly as feet 30 into matching grooves formed in inner side walls of the non-conductive insert 12 below walls 21 and 22.

The top wall 28 is substantially flush with the top surfaces of wall sections 31, 32 extending along the top edge of walls 22 and 21 respectively.

The metal insert 13 forms a central passage 33 which is occupied by the lower end of fastener 15.

As shown in FIG. 1 the wire screen mesh 14 is located so that its inner edge 34 abuts the right side of the vertical end section 35 of non-conductive insert 12. The bottom of the wire screen mesh 14 runs along the top surface of top wall 28 and walls 31 and 32 of the non-conductive insert. Clamping strip 16 which is a generally flat horizontally extending component rests on the opposite face of wire screen mesh 14 and assists in securely fixing the wire screen mesh 14 to the metal insert 13 when the fastener 15 is screwed through the clamping strip 16, wire screen mesh 14 and the top wall 28 of metal insert 13.

The non-conductive insert 12 is securely coupled to the outer frame by sliding it into place around the walls of the channel section 18. The metal insert 13 likewise is coupled to the non-conductive insert by sliding into the grooves of the channel formed by the inner walls of the non-conductive insert 12. By fastening the wire screen mesh to the metal insert 13, the wire screen mesh is effectively fastened to the outer frame 11.

Because the non-conductive insert 12 separates the clamping strip 16, wire screen mesh 14 and metal insert 13, all of which are conductive, from the outer frame which is also conductive, the outer frame is electrically isolated from the aforementioned components. Therefore a conductive path between these components is not possible and likewise corrosion resulting from a conductive path established between dissimilar metals is also avoided.

The cover 27 which fits over the fastener 15 and clamping strip 16 prevents unauthorised access to the fastener.

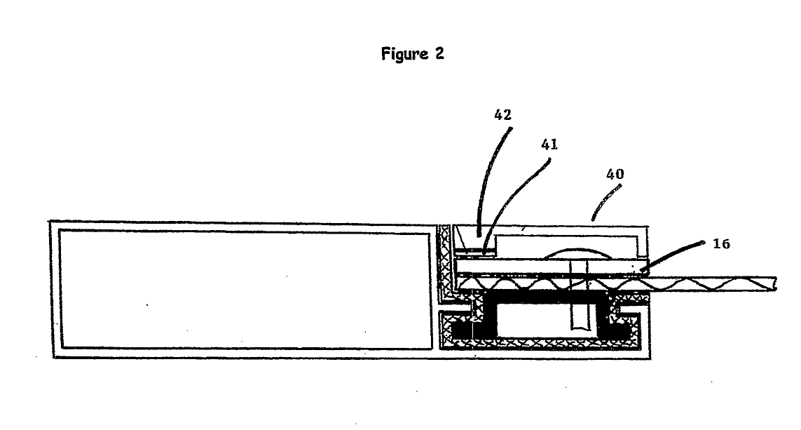

FIG. 2 shows an alternative embodiment to that shown in FIG. 1 in which the cover has a different design. Thus wall 24 is removed from the outer frame 17 and the cover is in the form of a generally flat horizontally extending component 40 which is fixed through double-sided tape to the outer end (in this case the left end) top surface of clamping strip 16. The outer end is similar in construction to that shown in FIG. 1. The outer (left) end of the cover 40 is also provided with a thick leg section 42 with a flat bottom surface to which the double-sided tape 41 is attached.

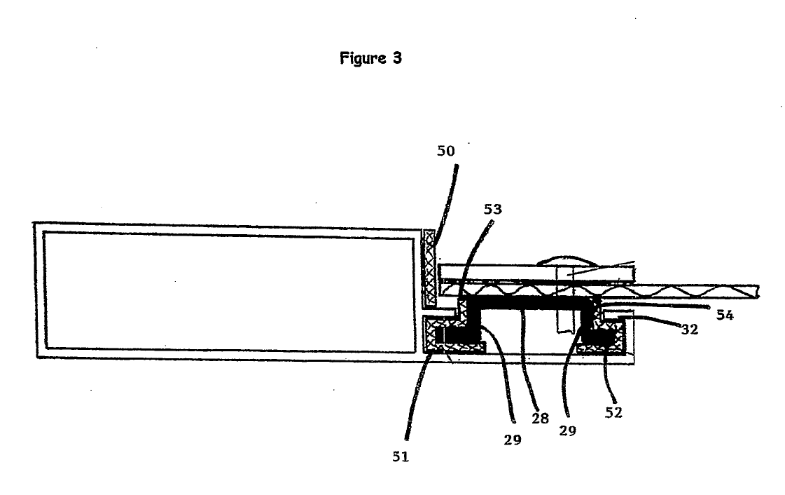

In FIG. 3 the non-conductive insert 12 is replaced by three separate non-conductive insert parts 50, 51, 52. In contrast to the second embodiment the non-conductive insert 12, inner and outer (left and right) insert sections 51 and 52 are provided which extend from just inside the inner edge of the heel of the metal insert 13 along the outer edges of the feet 30 underneath wall section 22 and along the outer edge of vertical wall section 29 and terminating flush with the top surface 28.

A gap then exists between the side edge of upper vertical wall section 53 and the outer side wall of vertically extending strip 50. Wall section 54 does not extend to the right laterally along the top surface of wall section 32.

The three components making up the non-conductive insert may be in the form of insulative tape. This is also applicable to the non-conductive insert of the first and second embodiments.

According to the fourth embodiment of the invention the non-conductive insert has a slightly different configuration and extends from the inner top edge of metal insert 13 around its exterior surface to the outer top edge thereof. Furthermore the shape of the metal insert 46 is also slightly different as it has a base wall extending between what would be lateral walls 30 in the previous embodiments. Thus the base wall 36 is continuous resulting in the metal insert 44 forming a rectangular tube.

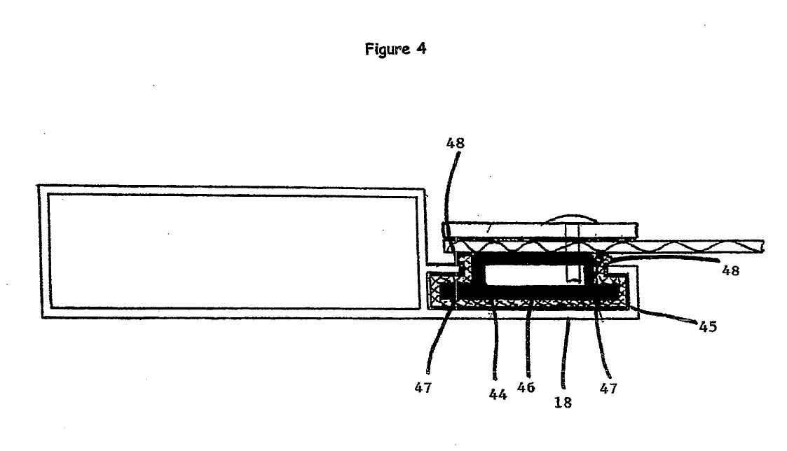

An insulative component 50 may also be added but has been excluded from FIG. 4.

In addition to the above it is noted that the inner and outer ends of the non-conductive insert 45 are provided with lateral lips 48 which abut the outer top edges of the wall sections 21 and 22. This serves to provide tighter coupling between the non-conductive insert 45 and the channel 18.

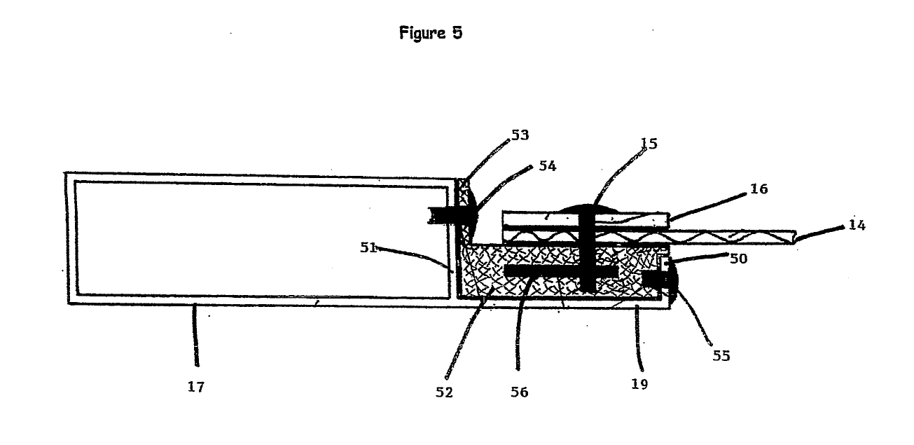

In FIG. 5 channel section 18 is replaced by a single lateral base wall 19 with an upright wall section 50 at its outer (right side) end thereof.

The non-conductive insert 12 is in the form of a non-conductive generally rectangular block 51 which fills the channel between wall 50 and wall 51 of the rectangular section 17. The top end of wall 50 terminates slightly less than half way up the corresponding level of wall 51. The non-conductive insert 52 has a generally horizontal top surface which has a lip 53 or ridge which extends over the top edge of wall 50.

At its inner (left) end non-conductive block 52 extends upwardly in a vertical wall section 53 which abuts the entire length of wall 51. Fasteners 54, 55 fix wall 53 to wall 51 and wall 50 to the side of block 52.

A flat metal insert strip 56 is located approximately in the middle of block 52 and runs parallel to the top surface of the block 52 and wall 19. Fastener 15 connects clamping strip 16 and wire screen mesh 14 to the metal insert 56.

The block 52 may be a solid ridge block or may be a soft pliable non-conductive compound.

It is preferred that the fastener 15 is screwed into the metal insert 56.

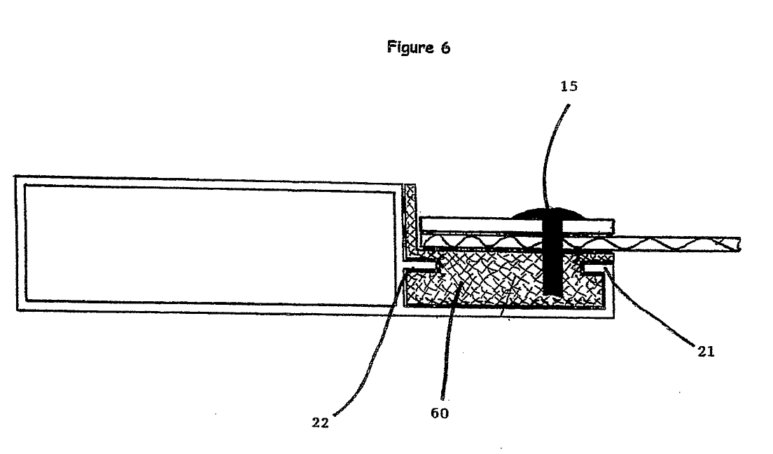

According to the sixth embodiment of the invention shown in FIG. 6 the outer frame has a similar construction to that shown in FIG. 2. However the non-conductive insert 12 is in the form of a non-conductive insert block 60 which not only extends along the inner surface of channel 18, but fills the channel to a level outside of the lateral walls 21, 22 to a level similar to that provided by the top surface of the metal insert shown in FIG. 1. Fastener 15 is attached in this case directly to the non-conductive insert 60.

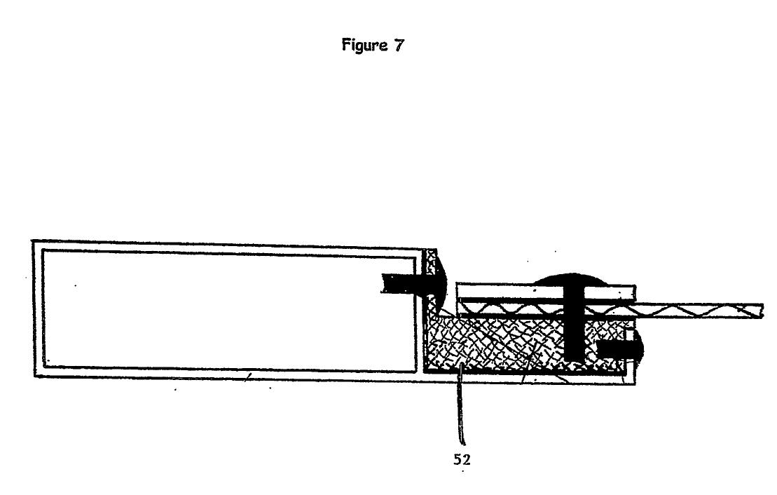

In the seventh embodiment of the invention shown in FIG. 7 embodiment 5 is slightly altered to remove the metal insert. The rest of the features of the embodiment are the same as shown in FIG. 5.

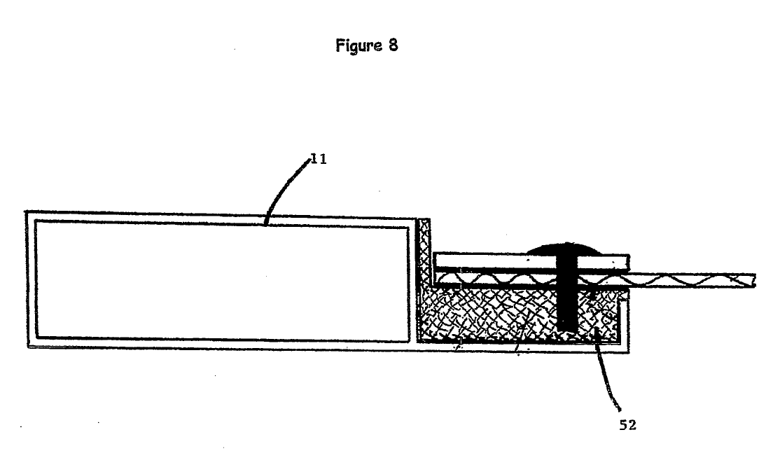

As shown in FIG. 8, in the eighth embodiment, the non-conductive block 52 is coupled to the outer frame 11 by an adhesive. Thus the fasteners 54 and 55 are excluded.

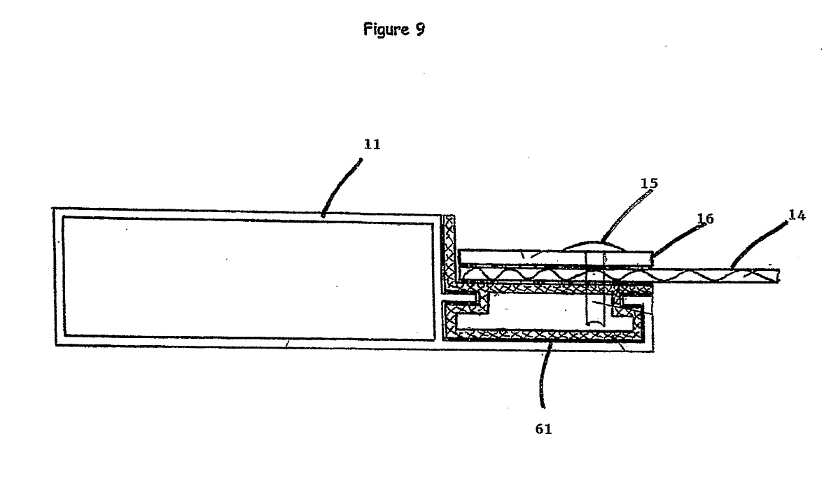

According to the ninth embodiment of the invention shown in FIG. 9, the non-conductive insert is removed and replaced by a conductive element which has an external profile which is similar to the non-conductive insert shown in FIG. 8. In addition however a central passage is provided which has a shape similar to the shape of the metal insert shown in FIG. 4. Thus the metal insert 61 shown couples directly to the outer frame which in this embodiment is non-conductive rather than conductive as in all the previously described embodiments.

The fastener 15 fastens the clamping strip 16, wire screen mesh 14 and metal insert 61 together.

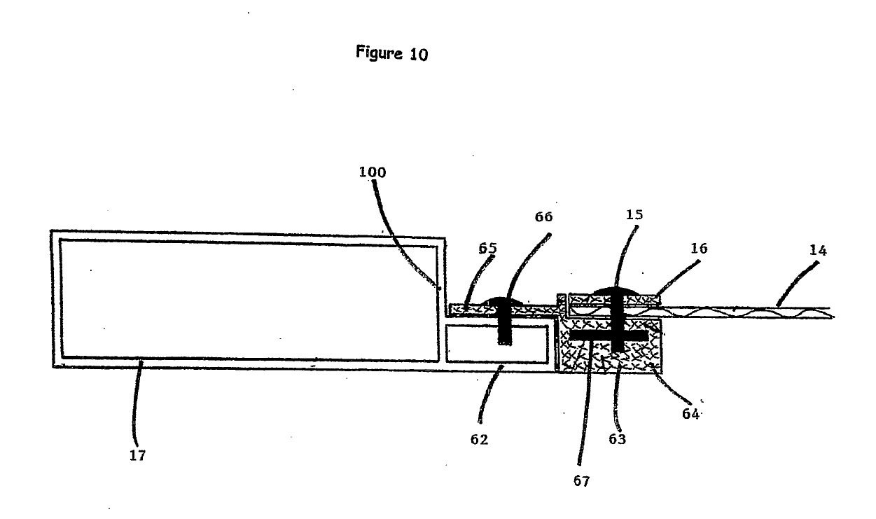

According to the tenth embodiment of the invention shown in FIG. 10 the outer frame is provided with a smaller rectangular tubular section 62 extending from a lower side of inner side wall 100 of the larger rectangular section 17.

A non-conductive component 63 is provided consisting of a rectangular section 64 located in abutting side by side relationship with section 62 and having an inwardly directed horizontal lateral wall 65 extending over and along the top wall of section 62. This lateral section 65 is fastened to section 62 by a fastener 66.

The non-conductive component 64 also has a small upright wall extension 67 extending from the top left hand corner (top inner corner) to provide an inner abutment wall for the innermost edges of the clamping strip 16 and wire screen mesh 14.

The non-conductive component 64 is a generally solid non-conductive block and has a conductive metal strip inserted in a similar fashion to that shown in FIG. 5. Fastener 15 attaches the clamping strip 16, wire screen mesh 14 and metal insert 67 together.

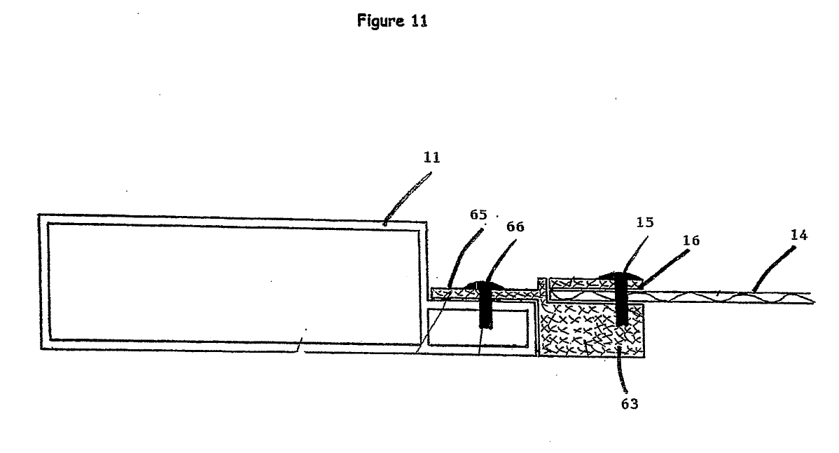

In FIG. 11 the eleventh embodiment of the invention is shown which is effectively the same as the tenth embodiment except the conductive metal strip 67 has been removed from the non-conductive component 63.

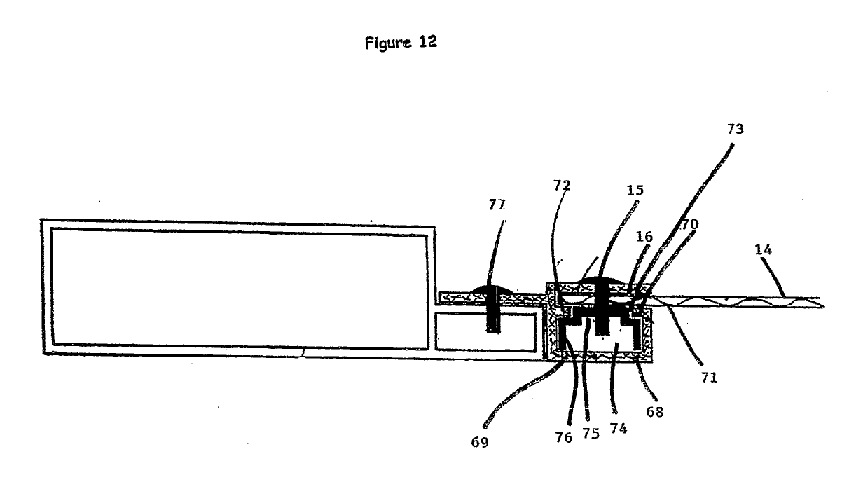

In a variation to the embodiment shown in FIGS. 10 and 11, FIG. 12 shows the twelfth embodiment of the invention in which the solid non-conductive block 63 is replaced by a non-conductive element 68. In this embodiment the rectangular block section 64 is replaced by a channel section 69 with an opening 70 in its top wall 71, thus the result is two horizontally extending wall portions 72 with the opening 70 therebetween and channel 74 therebelow.

A metal insert 75 consists of a flat horizontal section bridging the opening 70 between walls 72 and 73 with side walls extending downwardly following the inner profile of section 68 and terminating on top of the base wall of section 68. Fastener 15 connects clamping strip 16, wire screen mesh 14 and the metal insert together and fastener 77 connects inwardly directed horizontal section 65 to the outer frame in a similar fashion to embodiments 10 and 11. Thus the non-conductive component mainly differs from embodiments 10 and 11 by replacing the solid rectangular block section 64 with the equivalent channel section 68.

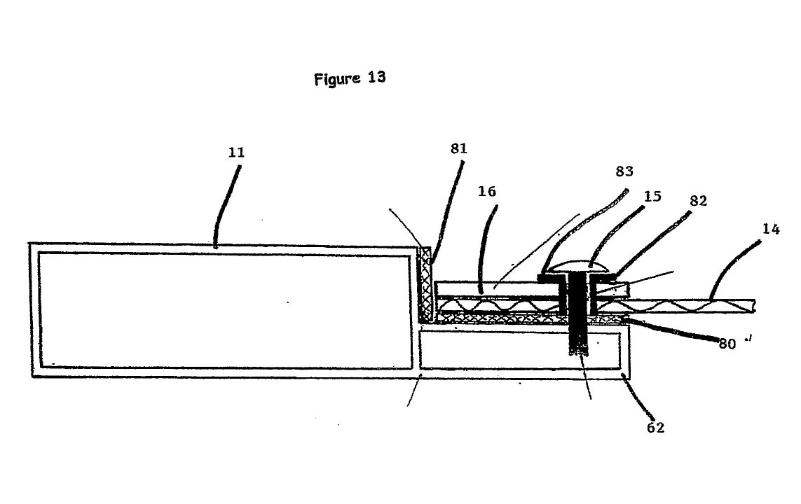

According to the thirteenth embodiment of the invention shown in FIG. 13 the outer frame is provided with an elongate rectangular tubular section 62.

Clamping strip 16 and wire screen mesh 14 are fastened to the top of section 62 through a non-conductive horizontal strip 80. In addition the inner edges of clamping strip 16 and wire screen mesh 14 are insulated from the adjacent side wall of the outer frame 11 by a vertically oriented non-conductive strip 81.

In addition to the above because the fastener 15 is fastened directly to the outer frame 62 a non-conductive sleeve 82 is provided which extends through both the clamping strip 16 and wire screen mesh 14.

The non-conductive sleeve 82 is a generally cylindrical tubular element with a collar 83 which rests on the upper surface of the clamping strip 16.

The non-conductive sleeve ensures that the clamping strip 16 and wire screen mesh 14 are electrically isolated from the fastener 15 and outer frame 11.

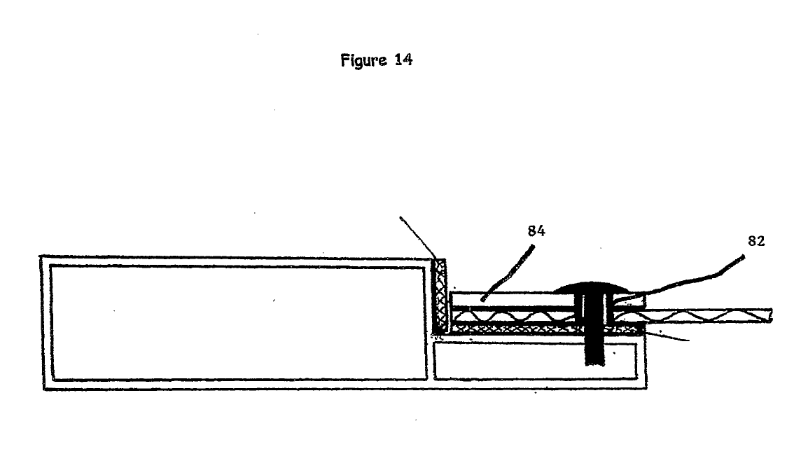

In a variation to the thirteenth embodiment, FIG. 14 shows the fourteenth embodiment in which the clamping strip 84 is made from a non-conductive material. Thus in this embodiment the non-conductive sleeve does not require a collar 83.

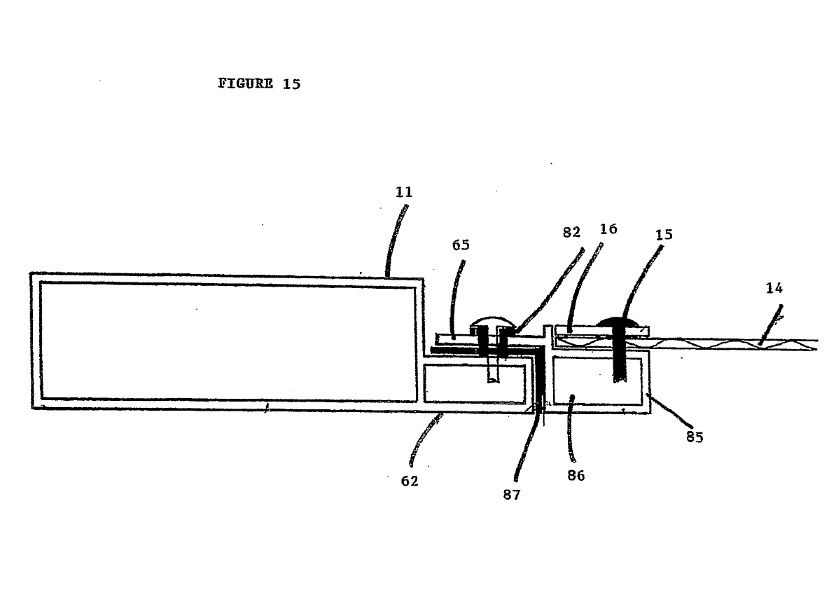

According to the fifteenth embodiment of the present invention shown in FIG. 15 a conductive component 85 is provided which has a similar external profile to the non-conductive component 63 shown in FIG. 11. However as component 85 is conductive it is formed as a tube with a rectangular passage 86, rather than being made of a solid conductive block.

The clamping strip 16 and wire screen mesh 14 are fastened directly to the conductive component 85 by fastener 15 in a similar fashion to that described in relation to the ninth embodiment. In addition however although a fastener 87 is provided to connect the inwardly directed extension 65 to rectangular section 62 of the outer frame a non-conductive sleeve 82 is utilised. Furthermore, a non-conductive right angled strip 87 is inserted between the conductive component 85 and the section 62. This results in the conductive component 85 being electrically isolated from the outer frame 11.

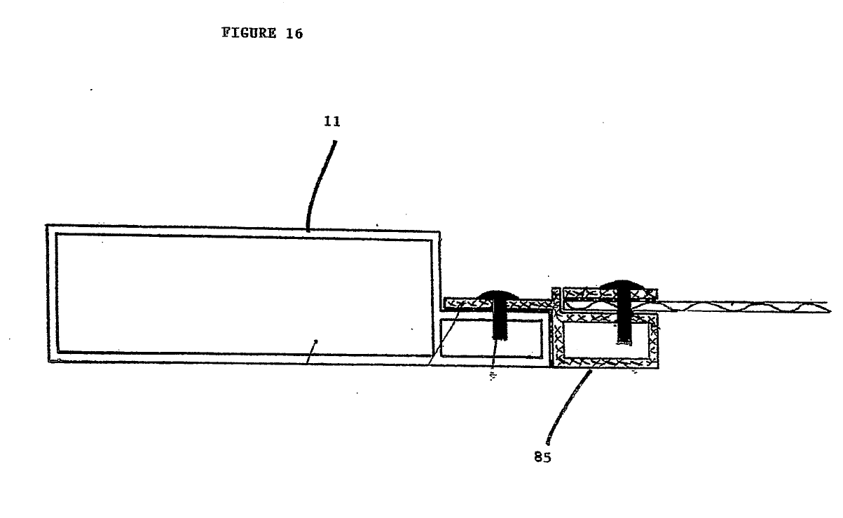

According to a sixteenth embodiment of the present invention as shown in FIG. 16, a metal component 85 is utilised which has a similar shape to that shown in FIG. 15. However the outer frame is made from a non-conductive material so that it may be fastened directly to the outer frame.

According to a seventeenth embodiment of the present invention an outer rectangular frame 88 is provided with a horizontal wall 89 extending inwardly from its bottom right hand corner. The distal end of wall 89 extends vertically upwardly and then outwardly (towards the outer frame) at right angles as walls 90 and 91. Another right angled wall section 92 extends upwardly from wall 89 closer to the right hand (inner) wall 93 of outer frame 88 and inwardly as wall 94. Walls 92 and 94 are generally symmetrical with walls 91 and 90. They form a channel 95 with a gap 96 between the ends of walls 91 and 94.

Two ridges 97, 98 extend upwardly from wall 89 between walls 90 and 92 and below the outer edges of walls 91 and 94. The distance between them is similar to the distance across the gap 96.

A wire screen mesh 120 is located in a recess 98 in a plastic clamping component 99 which is generally C-shaped but has generally long parallel upper and lower walls 100 and 101 separated by a short vertical section 108 at an inner end thereof and abutting the outer surface of wall 93.

The C-shaped member 99 is seated on the top walls 91 and 94 and includes a lower rectangular shaped foot or ridge which fits into the gap 96.

The bottom face of the foot 103 is flat and horizontal and is generally flush with the bottom edges of walls 91 and 94. It also rests on a plastic insulating channel section 104 which extends horizontally between walls 92 and 90 underneath walls 91 and 94 and at rights angles downwardly and again at right angles inwardly so as to rest upon ridges 97 and 98. A thin horizontally extending metal strip 105 is seated within the channel section 104 and is insulated from contact with the metal walls of the outer frame 88 and walls 89, 90, 91, 92, 93, 97 and 98.

A fastener (not shown) can be located through the horizontal walls 100, 101, foot 103, upper wall of channel section 104 and through the metal strip 105.

With the above embodiment it is possible to fasten a wire screen mesh to an outer frame 88 without any contact between the different metal components including the wire screen mesh, the metal strip 105 and the outer frame 88.

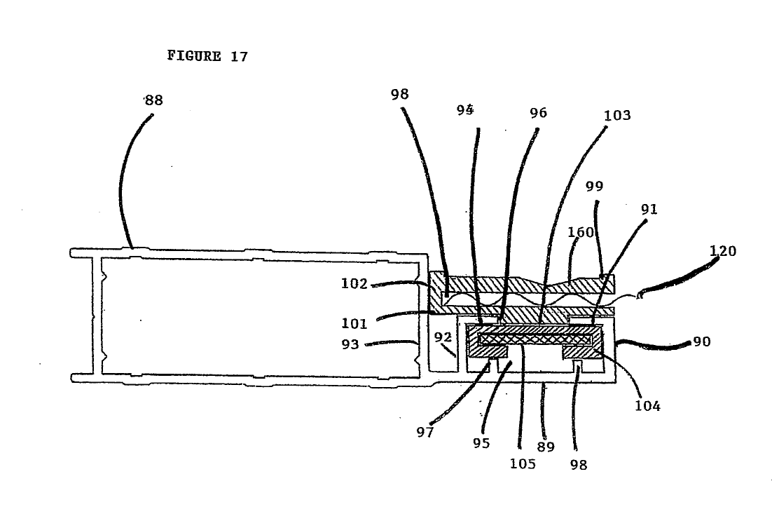

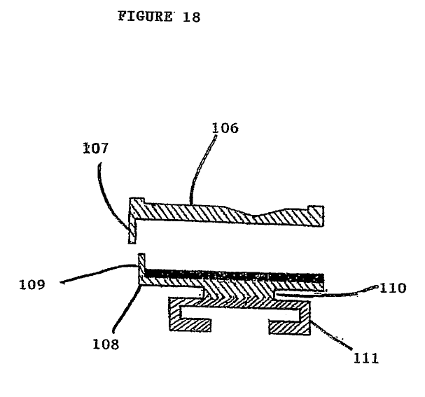

FIG. 18 shows a variation of the embodiments shown in FIG. 17 in which the C-shaped clamping member 99 is split into two pieces comprising an upper horizontal piece 106 with a downwardly extending wall 107 at its left end (outer-with regard to the orientation of the outer frame). The wall 107 extends in parallel with wall 93 of the outer frame 88.

A lower clamping member 107 extends horizontally in parallel with wall 106 and also has an upwardly extending wall 109 which is intended to extend parallel with wall 93 and at right angles to wall 108.

The foot 103 of FIG. 17 is provided on the bottom of wall 108 and extends into an integrally formed channel section 111 which is effectively the same in shape as channel section 104.

A metal strips fits in the channel in a similar fashion to that described in relation to FIG. 17.

The clamping components 106 and 108 can be used in FIG. 17 in lieu of the existing clamping components 99 and 104. In use the lower wall 107 fits behind the wall 109 and is thus prevented from being withdrawn because of the wall 109. A fastener fits through both clamping members in a similar fashion to that described in relation to FIG. 17.

In addition to the embodiment described above it is possible to vary the shape and/or configuration of each of the components as long as the resulting configuration ensures that the wire screen mesh is electrically isolated from the outer frame.

It is to be understood that, if any prior art publication is referred to herein, such reference does not constitute an admission that the publication forms a part of the common general knowledge in the art, in Australia or in any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

The claims defining the invention are as follows:

1. A frame assembly for a security screen comprising an outer frame, a screen, an attachment means, and an interconnecting means, wherein the attachment means attaches the screen to the interconnecting means and the interconnecting means interconnects the screen and the outer frame, and wherein the screen is electrically isolated from the outer frame.

2. The frame assembly as claimed in claim 1 wherein the interconnecting means comprises an intermediate coupling means for coupling with a frame coupling means of the outer frame.

3. The frame assembly as claimed in claim 2 wherein the intermediate coupling means comprises at least one male or female portion which is configured to couple with a complimentary male or female portion of the frame coupling means.

4. The frame assembly as claimed in claim 2 wherein the intermediate coupling means comprises a plurality of male or female or male and female portions configured to couple with complimentary female or male or female and male portions of the frame coupling means.

5. The frame assembly as claimed in claim 1 wherein the intermediate coupling means comprises lateral coupling portions.

6. The frame assembly as claimed in claim 5 wherein the lateral coupling portion comprise peripheral grooves.

7. The frame assembly as claimed in claim 5 wherein the lateral coupling portions are arranged symmetrically on opposite sides of the interconnecting means.

8. The frame assembly as claimed in claim 6 wherein the peripheral grooves are arranged symmetrically on opposite sides of the interconnecting means.

9. The frame assembly as claimed in claim 1 wherein the intermediate coupling means comprises a conductive means having a conductive part.

10. The frame assembly as claimed in claim 9 wherein the intermediate coupling means comprises a non-conductive means having a non-conductive part.

11. The frame assembly as claimed in claim 1 wherein the interconnecting means comprises both non-conductive and conductive parts.

12. The frame assembly as claimed in claim 11 wherein the non-conductive member comprises a screen mesh shielding portion configured to extend between an inner edge of the screen mesh and adjacent side wall of the outer frame.

13. The frame assembly as claimed in claim 11 wherein lateral portions of the conductive part are configured to fit into complimentary shaped recesses of the non-conductive part.

14. The frame assembly as claimed in claim 11 wherein the non-conductive part has an outer end portion which separates an adjacent part of the screen mesh from part of the outer frame.

15. The frame assembly as claimed in claim 1 wherein the attachment means comprises a clamping means for clamping the screen mesh to the intermediate means.

16. The frame assembly as claimed in claim 1 wherein the attachment means comprises a clamping means for clamping the screen mesh to the conductive part.

17. The frame assembly as claimed in claim 11 wherein the non-conductive part extends around the side walls and base of the conductive part.

18. The frame assembly as claimed in claim 11 wherein the conductive part is attached by adhesive to the non-conductive part.

19. The frame assembly as claimed in claim 11 wherein the conductive part comprises a conductive strip.

20. The frame assembly as claimed in claim 11 wherein the non-conductive means comprises a solid non-conductive member with the conductive part embedded therein.

21. The frame assembly as claimed in claim 11 wherein the intermediate coupling means fastens the side portion of the non-conductive member to an outer side wall of the outer frame.

22. The frame assembly as claimed in claim 11 wherein the conductive means comprises a conductive member with the intermediate coupling portions for coupling the conductive means to the outer frame.

23. The frame assembly as claimed in claim 11 wherein the non-conductive means comprises a generally rectangular block with an upstanding thin wall on one side.

24. The frame assembly as claimed in claim 23 wherein the non-conductive means comprises a generally rectangular block with a lip on an opposite side.

25. The frame assembly as claimed in claim 11 wherein the non-conductive means is received in a channel of the outer frame.

26. The frame assembly as claimed in claim 23 wherein the upstanding thin wall is attached to the outer frame.

27. The frame assembly as claimed in claim 2 wherein the intermediate coupling means comprises a conductor and the outer frame is a non-conductor.

28. The frame assembly as claimed in claim 25 wherein the non-conductive member comprises a lateral wall portion extending from one side of the generally rectangular block.

29. The frame assembly as claimed in claim 28 wherein the lateral wall extends from an upright thin wall.

30. The frame assembly as claimed in claim 29 wherein the lateral wall comprises a horizontal edge.

31. The frame assembly as claimed in claim 30 wherein the side wall and lateral wall abut adjacent walls of the outer frame.

32. The frame assembly as claimed in claim 31 wherein the lateral wall is fixed to the top wall of the outer frame by a fastening means.

33. The frame assembly as claimed in claim 26 wherein the conductive member is substantially flat and is located in the generally rectangular block.

34. The frame assembly as claimed in claim 11 wherein the attachment means comprises a fastening member which extends through the conductive member.

35. The frame assembly as claimed in claim 11 wherein the non-conductive member comprises a generally rectangular channel with an upper opening.

36. The frame assembly as claimed in claim 35 wherein the conductive member fits into the channel through the opening.

37. The frame assembly as claimed in claim 36 wherein the conductive member has a configuration similar to pat of the internal profile of the non-conductive member.

38. The frame assembly as claimed in claim 37 wherein the conductive member comprises left and right side wall portions which abut corresponding portions of the non-conductive member.

39. The frame assembly as claimed in claim 38 wherein the conductive member has a flat top wall.

40. The frame assembly as claimed in claim 39 wherein a fastener attaches to the top flat top wall.

41. A frame assembly for a security screen comprising an outer frame, a screen, an attachment means and an isolating means, wherein the attachment means attaches the screen to the outer frame and the isolating means electrically isolates the attachment means from the screen.

42. The frame assembly as claimed in claim 41 wherein the isolating means comprises a washer to prevent the sleeve from falling through a hole within the screen.

43. The frame assembly as claimed in claim 42 wherein the attachment means comprises a fastener which in use fits through the sleeve member.

44. The frame assembly as claimed in claim 42 wherein the attachment means comprises a clamping means for clamping the screen mesh to the conductive part.

45. The frame assembly as claimed in claim 44 wherein the isolating means through the clamping member.

46. The frame assembly as claimed in claim 41 including at least one insulating strip located in use between the screen and a top wall portion of the outer frame.

47. The frame assembly as claimed in claim 41 including at least one insulating strip between ends of the screen and side wall portion of the outer frame.

48. The frame assembly as claimed in claim 41 wherein the sleeve member comprises a tubular member with a top collar.

49. The frame assembly as claimed in claim 11 wherein the conductive member comprises a lateral wall in use configured to extend over a top wall portion of the outer frame.

50. The frame assembly as claimed in claim 41 wherein the conductive member comprises an upstanding wall portion extending from one side.

51. The frame assembly as claimed in claim 41 wherein the side wall portion has an opening for receipt of the isolating means.

52. The frame assembly as claimed in claim 30 wherein the non-conductive means comprises an insulating member extending along a portion of the outer frame to separate the conductive member from it.

53. The frame assembly as claimed in claim 45 wherein the isolating means extends through the insulating strip

54. According to another aspect of the present invention there is provided a frame assembly for a security screen comprising an outer frame, a screen, an attachment means and an isolating means, wherein the attachment means attaches the screen to the outer frame and the isolating means electrically isolates the attachment means from the screen.

55. A frame assembly substantially as hereinbefore described with reference to any one of the embodiments shown in FIGS. 1 to 18.

56. The frame assembly as claimed in claim 1 wherein the interconnecting means comprises a plurality of insulating members.

57. The frame assembly as claimed in claim 56 wherein the interconnecting means comprises a non-conductive clamping member having upper and lower clamping walls.

58. The frame assembly as claimed in claim 57 wherein the non-conducting clamping member is substantially C-shaped.

59. The frame assembly as claimed in claim 57 wherein the non-conducting clamping member is configured to sit on supporting walls of the outer frame.

60. The frame assembly as claimed in claim 57 wherein the non-conductive member comprises a lower foot portion extending from the lower clamping wall.

61. The frame assembly as claimed in claim 57 wherein the interconnecting means comprises a channel component which is non-conductive and configured to be located within a recessed area of the outer frame.

62. The frame assembly as claimed in claim 61 wherein the interconnecting means includes a conductive member which is configured to be located below the non-conductive member.

63. The frame assembly as claimed in claim 62 wherein the conductive member is housed within a non-conductive sheath member.
